(19) United States
(12) Patent Application Publication
(10) Pub. No.: US 2022/0176555 A1
(43) Pub. Date: Jun. 9, 2022

(54) NON-TRANSITORY COMPUTER-READABLE STORAGE MEDIUM AND TEACHING METHOD FOR ROBOT

(71) Applicant: Seiko Epson Corporation, Tokyo (JP)

(72) Inventor: Masaaki HAGIO, Matsumoto (JP)

(21) Appl. No.: 17/540,748

(22) Filed: Dec. 2, 2021

(30) Foreign Application Priority Data
Dec. 3, 2020 (JP) 2020-201003

(51) Int. Cl. B25J 9/16

(52) U.S. Cl. CPC B25J 9/163; G05B 2219/39001; B25J 9/1664

(57) ABSTRACT

A non-transitory computer-readable storage medium storing a computer program, the computer program controlling a processor to execute visualizing processing of displaying virtual lines visualized in positions of axial lines with respect to a plurality of twisting joints of a robot when a predetermined condition is satisfied.

The present application is based on, and claims priority from JP Application Serial Number 2020-201003, filed Dec. 3, 2020, the disclosure of which is hereby incorporated by reference herein in its entirety.

### BACKGROUND

### 1. Technical Field

The present disclosure relates to a non-transitory computer-readable storage medium and a teaching method for a robot.

### 2. Related Art

JP-A-2018-202514 discloses an information processing apparatus for performing teaching of a robot. In the related art, the trajectory of the robot is superimposed and displayed on an image of the robot, and the trajectory portion close to the singular configuration of the robot may be visually distinguished in display.

However, in the related art, there is a problem that it is difficult to easily recognize an operation to avoid the singular configuration in the trajectory portion close to the singular configuration.

### SUMMARY

According to a first aspect of the present disclosure, a non-transitory computer-readable storage medium storing a computer program is provided. The computer program controls a processor to execute visualizing processing of displaying virtual lines visualized in positions of axial lines with respect to a plurality of twisting joints of a robot when a predetermined condition is satisfied.

According to a second aspect of the present disclosure, a teaching method for a robot is provided. The teaching method includes visualizing of displaying virtual lines visualized in positions of axial lines with respect to a plurality of twisting joints of a robot when a predetermined condition is satisfied.

### BRIEF DESCRIPTION OF THE DRAWINGS

FIG. 1 is an explanatory diagram of a robot system in a first embodiment.

FIG. 2 is a functional block diagram of an information processing apparatus.

FIG. 3 is a flowchart showing a procedure of teaching processing in an embodiment.

FIG. 4 is an explanatory diagram showing an example of a teaching processing window.

FIG. 5 is an explanatory diagram showing an example of a case where a display form of visualized axial lines is changed.

FIG. 6 is an explanatory diagram showing another example of the case where the display form of the visualized axial lines is changed.

FIG. 7 is an explanatory diagram showing yet another example of the case where the display form of the visualized axial lines is changed.

FIG. 8 is an explanatory diagram of a robot system in a second embodiment.

### DESCRIPTION OF EXEMPLARY EMBODIMENTS

### A. First Embodiment

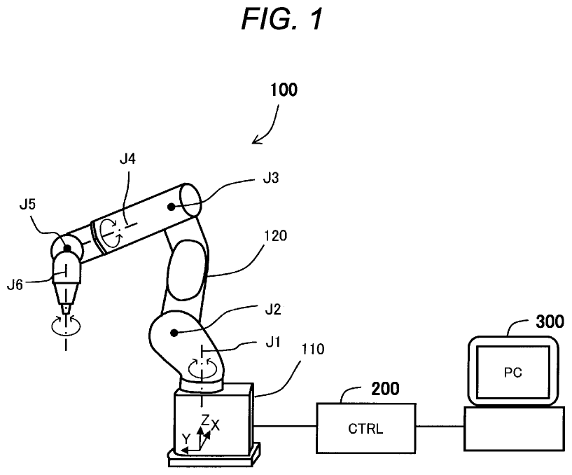

FIG. 1 is an explanatory diagram showing a robot system in a first embodiment. The robot system includes a robot 100, a control apparatus 200 that controls the robot 100, and an information processing apparatus 300. The information processing apparatus 300 is e.g. a personal computer. In FIG. 1, three axes X, Y, Z defining an orthogonal coordinate system in a three-dimensional space are drawn. The X-axis and the Y-axis are axes in horizontal directions and the Z-axis is an axis in vertical directions. In this example, the XYZ coordinate system is a robot coordinate system having the origin at a preset reference point for the robot 100.

The robot 100 includes a base 110 and an arm 120. The arm 120 is sequentially coupled by six joints J1 to J6. Of these joints J1 to J6, the three joints J1, J4, J6 are twisting joints and the other three joints J2, J3, J5 are bending joints. The twisting joint is a joint that can make twisting motion around an axial line of a rotation axis. In the embodiment, a six-axis robot is exemplified, however, a robot including an arbitrary arm mechanism having two or more twisting joints can be used. The robot 100 of the embodiment is a vertical articulated robot, however, a horizontal articulated robot may be used.

Generally, a configuration in which the axial lines of the two twisting joints are in the same straight line is a singular configuration because the joint angle is not uniquely obtained by inverse kinematics from coordinates in the orthogonal coordinate system. In consideration of the characteristics, the present disclosure is configured so that a teacher may easily recognize whether or not the configuration is close to a singular configuration and an operation to avoid the singular configuration.

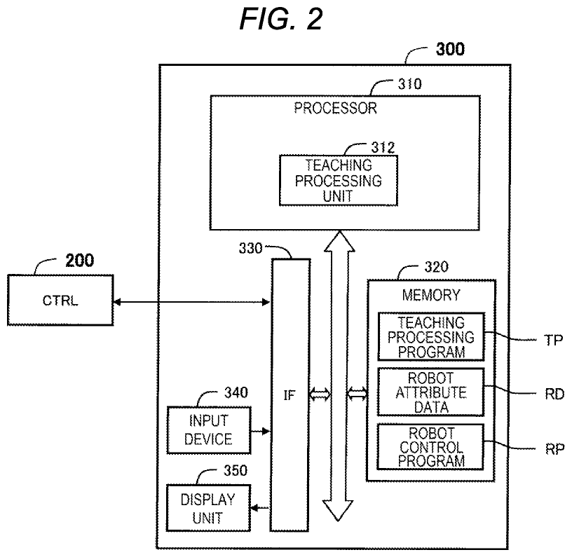

FIG. 2 is a functional block diagram of the information processing apparatus 300. The information processing apparatus 300 has a processor 310, a memory 320, an interface circuit 330, and an input device 340 and a display unit 350 coupled to the interface circuit 330. Further, the control apparatus 200 is coupled to the interface circuit 330. Note that the information processing apparatus 300 is not necessarily coupled to the control apparatus 200.

The processor 310 functions as a teaching processing unit 312 that executes teaching processing of the robot 100. The function of the teaching processing unit 312 is realized by the processor 310 executing a teaching processing program TP stored in the memory 320. Note that part or all of the functions of the teaching processing unit 312 may be realized by a hardware circuit.

In the memory 320, robot attribute data RD and a robot control program RP are stored in addition to the teaching processing program TP. The robot attribute data RD contains various robot characteristics including the configuration and the movable range of the arm of the robot 100. The robot control program RP includes a plurality of commands for moving the robot 100.

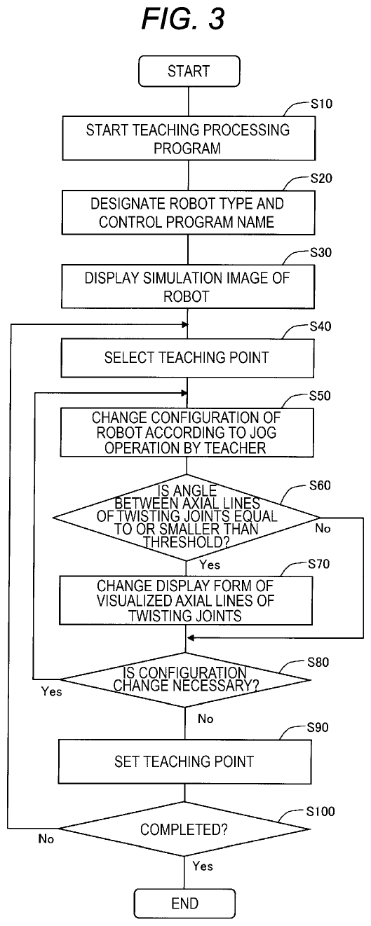

FIG. 3 is a flowchart showing a procedure of the teaching processing in one embodiment. At step S10, a teacher starts the teaching processing program TP. At step S20, the teacher designates a robot type of a robot to be taught and a program name of a robot control program to be edited. At step S30, a simulation image of the robot of the designated type is displayed on the display unit 350.

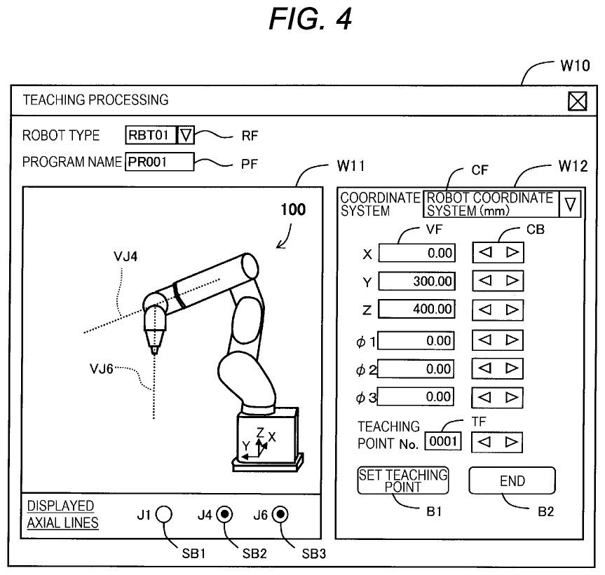

FIG. 4 is an explanatory diagram showing an example of a teaching processing window W10 displayed on the display unit 350 for teaching processing using the teaching processing program TP. The teaching processing window W10 contains a robot select field RF for selection of the robot type, a program select field PF for designation of the program name of the robot control program, a robot display window W11 for displaying the simulation image of the robot 100, and a jog operation window W12 for inputting a jog operation.

In the robot display window W11, a simulation image containing a three-dimensional image of the robot 100 is displayed. Further, in the lower part of the robot display window W11, select buttons SB1 to SB3 are provided for selection of the axial lines to be superimposed and displayed on the robot 100 within the robot display window W11 of the axial lines of the plurality of twisting joints J1, J4, J6 of the robot 100. For notification of the closeness to the singular configuration to the teacher, it is preferable to select the axial lines of the two or more twisting joints. In the example of FIG. 4, the axial lines of the two twisting joints J4, J6 are selected to be displayed and, in response thereto, visualized axial lines VJ4, VJ6 as virtual lines visualized in the positions of the axial lines of the two twisting joints J4, J6 are displayed in a three-dimensional image of the robot 100. When all of the select buttons SB1 to SB3 are selected, the visualized axial lines are respectively displayed in the positions of the axial lines of the three twisting joints J1, J4, J6.

Visualizing processing of displaying the visualized axial lines VJ4, VJ6 of the two twisting joints J4, J6 is executed when a predetermined condition is satisfied. For example, when one or more conditions preselected from the following exemplified conditions 1 to 4 are satisfied, satisfaction of “predetermined condition” may be determined.

Condition 1: Reception of an Instruction to Teach the Robot from the Teacher

For example, satisfaction of the condition 1 is determined when the type of the robot is selected using the robot select field RF. Or, in a case where the type of the robot is initially set in the teaching processing program TP, the satisfaction of the condition 1 may be determined when the teacher starts the teaching processing program TP.

Condition 2: Reception of an Instruction to Display a Plurality of Visualized Axial Lines from the Teacher

Satisfaction of the condition 2 may be determined when the teacher sets the select buttons SB1 to SB3 in FIG. 4.

Condition 3: An Angle Between the Two Axial Lines of the Plurality of Axial Lines of the Plurality of Twisting Joints being Equal to or Smaller than a Predetermined Threshold

Whether or not the condition 3 is satisfied may be determined, when position and configuration of the robot 100 are changed by a jog operation by the teacher, by calculation of joint displacement using inverse kinematics from the position and configuration and obtainment of an angle of the bending joint J5. The threshold of the condition 3 is set to a value in a range from 3 to 10 degrees.

### Condition 4: A Jog Operation Performed in the Orthogonal Coordinate System

Satisfaction of the condition 4 may be determined when the orthogonal coordinate system including the robot coordinate system and the tool coordinate system is selected in the jog operation window W12.

In the embodiment, only the condition 1 is employed as the predetermined condition for starting display of the visualized axial line. Specifically, when the type of the robot is selected using the robot select field RF, display of the visualized axial lines VJ4, VJ6 is started with display of the three-dimensional image of the robot 100. Note that, when the condition 3 is employed as the predetermined condition for starting the display of the visualized axial lines VJ4, VJ6, the visualized axial lines VJ4, VJ6 are not displayed in the state of FIG. 4 and the visualized axial lines VJ4, VJ6 are not displayed until the angle between these axial lines is equal to or smaller than the threshold.

The jog operation window W12 contains a coordinate system select field CF for selection of a coordinate system, a coordinate value field VF for designation of six coordinate values according to the selected coordinate system, a teaching point field TF for designation of a teaching point to be edited, a teaching point set button B1, and an end button B2. Increase or decrease buttons CB for increasing or decreasing values are placed on the right sides of the individual coordinate value fields VF and the right side of the teaching point field TF.

The coordinate system select field CF is a field for selection of arbitrary one of the robot coordinate system, the tool coordinate system, and the joint coordinate system. In the example of FIG. 4, the coordinate system select field CF is formed as a pull-down menu. The robot coordinate system and the tool coordinate system are orthogonal coordinate systems. When a jog operation is performed in the orthogonal coordinate system, joint coordinate values are calculated by inverse kinematics and the singular configuration is problematic. On the other hand, in the joint coordinate system, the calculation by inverse kinematics is unnecessary and the singular configuration is not problematic. Therefore, it is preferable that the display of the visualized axial lines VJ4, VJ6 is executed when the jog operation is performed in the orthogonal coordinate system.

At step S40 in FIG. 3, the teaching point is selected by the teacher. The selection of the teaching point is performed by setting of the value of the teaching point field TF. At step S50, the configuration of the robot 100 is changed according to the jog operation by the teacher in the jog operation window W12. At step S60, the teaching processing unit 312 determines whether or not the angle between the axial lines of the twisting joints J4, J6 to be visualized is equal to or smaller than the threshold. When the angle is larger than the threshold, the process goes to step S80, which will be described later. On the other hand, when the angle between the axial lines of the twisting joints J4, J6 is equal to or smaller than the threshold, the process goes to step S70, and the teaching processing unit 312 changes the display form of the visualized axial lines VJ4, VJ6.

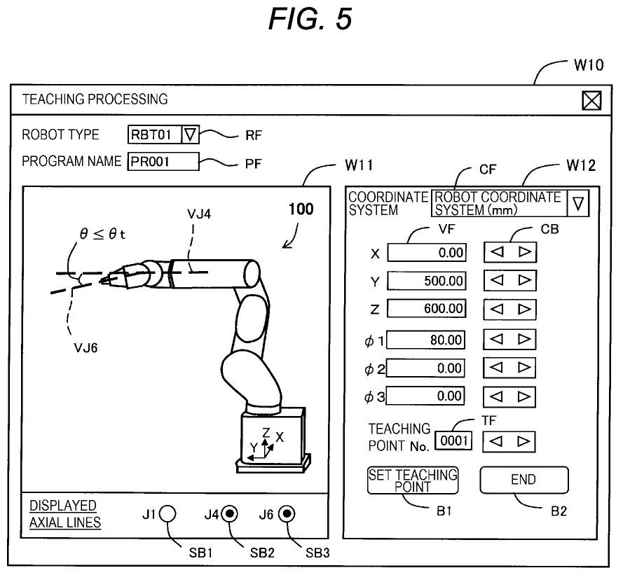

FIG. 5 is an explanatory diagram showing an example of the case where the display form of the visualized axial lines VJ4, VJ6 is changed. In this example, an angle θ between the axial lines of the twisting joints J4, J6 is equal to or smaller than a threshold Ot, and the display form of the visualized axial lines VJ4, VJ6 is changed from that in FIG. 4. Specifically, for example, when the angle θ between the axial lines of the twisting joints J4, J6 is equal to or smaller than the threshold θt, the color of at least one of the two visualized axial lines VJ4, VJ6 is changed to a color different from the color when the angle θ is larger than the threshold θt. In this manner, the color of the visualized axial line is changed, and thereby, closeness to the singular configuration may be warned to the teacher.

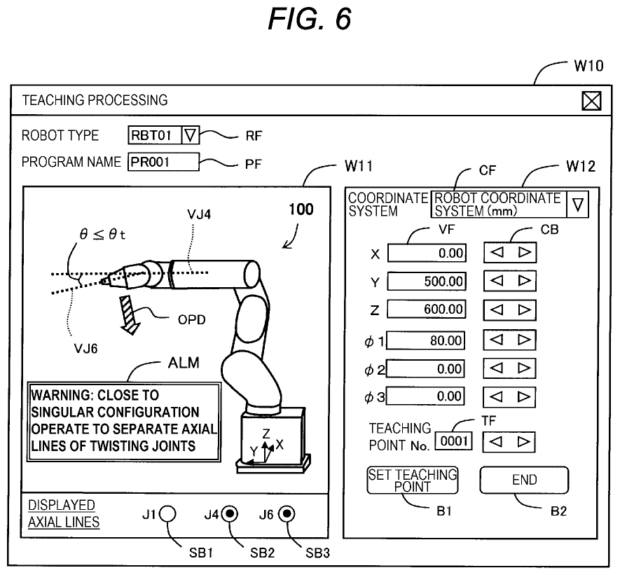

FIG. 6 is an explanatory diagram showing another example of the case where the display form of the visualized axial lines VJ4, VJ6 is changed. In this example, an operation instruction to prompt the teacher to perform an operation to increase the angle between the axial lines of the twisting joints J4, J6 is displayed within the robot display window W11. Specifically, as the operation instruction, an arrow OPD prompting a jog operation in a direction in which the angle between the two visualized axial lines VJ4, VJ6 increases and a warning ALM are displayed. As the operation instruction, only one of the arrow OPD and the warning ALM may be displayed, or another kind of operation instruction may be displayed. The operation instruction is displayed, and thereby, an operation for separating from the singular configuration may be notified to the teacher.

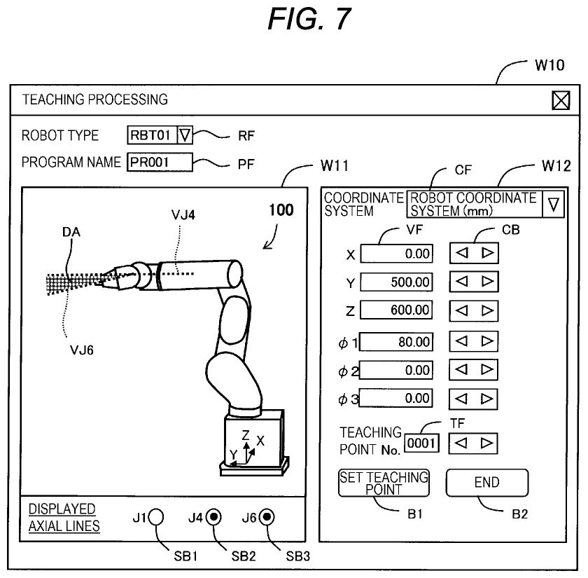

FIG. 7 is an explanatory diagram showing another example of the case where the display form of the two visualized axial lines VJ4, VJ6 is changed. In this example, a dangerous area DA showing closeness to the singular configuration is displayed near the two visualized axial lines VJ4, VJ6. Specifically, the dangerous area DA is displayed by provision of a specific color to the area sandwiched by the two visualized axial lines VJ4, VJ6. Note that the dangerous area DA may spread out of the area sandwiched by the two visualized axial lines VJ4, VJ6 as long as the area is set near the two visualized axial lines VJ4, VJ6. The dangerous area DA is displayed, and thereby, the dangerous area DA close to the singular configuration may be notified to the teacher.

The above described changes of the display forms of the visualized axial lines VJ4, VJ6 shown in FIGS. 5 to 7 may be arbitrarily combined.

At step S80 in FIG. 3, the teacher determines whether or not a configuration change of the robot 100 is necessary. When the teacher determines that a configuration change is necessary, the process returns to step S50 and the above described steps S50 to S70 are executed again. On the other hand, when a configuration change is not necessary, the process goes to step S90 and a teaching point is set. The setting of the teaching point is executed by the teacher pressing the teaching point set button B1. Coordinate values of the set teaching point are registered in the robot control program RP.

At step S100, whether or not teaching processing is completed is determined by the teacher. When the teaching processing is not completed, the process returns to step S40 and the above described steps S40 to S90 are repeated. On the other hand, when the teaching processing is completed, the processing in FIG. 3 is ended by the teacher pressing the end button B2.

As described above, in the above described first embodiment, the visualized axial lines VJ4, VJ6 as the virtual lines visualized in the positions of the axial lines are displayed with respect to the plurality of twisting joints J4, J6, and thereby, the teacher may easily determine the closeness to the singular configuration in which the axial lines of the two twisting joints J4, J6 are aligned in a straight line. Further, the teacher may easily recognize that the singular configuration is avoidable by the operation to set the angle between the two virtual lines not to 0 degrees.

### B. Second Embodiment

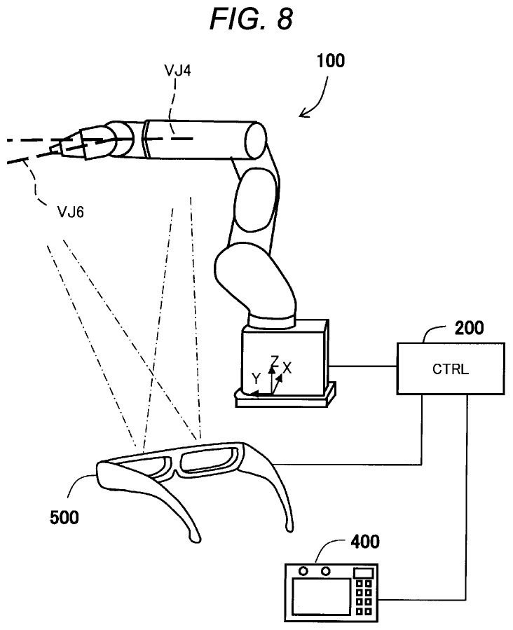

FIG. 8 is an explanatory diagram showing a robot system in a second embodiment. The robot system has a configuration in which the information processing apparatus 300 is omitted from the robot system of the first embodiment shown in FIG. 1 and a teaching pendant 400 and a see-through head mounted display 500 are added thereto. The configuration of the robot 100 is the same as that of the first embodiment. The teaching pendant 400 and the head mounted display 500 are respectively coupled to the control apparatus 200 of the robot 100. Note that the head mounted display 500 is attached to the head of the teacher, however, the illustration of the teacher is omitted.

In the second embodiment, the teacher executes teaching processing of the robot 100 using the teaching pendant 400. The teaching pendant 400 is configured to perform almost all processing and instructions except display of the simulation image of the teaching processing window W10 shown in FIG. 4. The function of the teaching processing by the teaching pendant 400 is realized by a processor of the teaching pendant 400 executing a computer program stored in a memory within the teaching pendant 400.

In the second embodiment, visualizing processing of displaying the visualized axial lines with respect to the twisting joints is performed by the head mounted display 500. That is, display by the head mounted display 500 is executed so that the teacher may visually recognize a state in which the plurality of visualized axial lines VJ4, VJ6 are displayed in the positions of the plurality of axial lines of the plurality of twisting joints of the robot 100 as a real machine. Regarding the conditions for starting display of the plurality of visualized axial lines VJ4, VJ6 and the display forms, those explained in the first embodiment can be applied.

Also, in the second embodiment, like the above described first embodiment, the visualized axial lines VJ4, VJ6 as the virtual lines visualized in the positions of the axial lines are displayed with respect to the plurality of twisting joints J4, J6, and thereby, the teacher may easily determine the closeness to the singular configuration in which the axial lines of the two twisting joints J4, J6 are aligned in a straight line. Further, the teacher may easily recognize that the singular configuration is avoidable by the operation to set the angle between the two virtual lines not to 0 degrees.

### C. Other Embodiments

The present disclosure is not limited to the above described embodiments, but may be realized in various aspects without departing from the scope thereof. For example, the present disclosure can be realized in the following aspects. The technical features in the above described embodiments corresponding to the technical features in the following respective aspects can be appropriately replaced or combined to solve part or all of the problems of the present disclosure or achieve part or all of the effects of the present disclosure. The technical features not described as essential features in this specification can be appropriately deleted.

(1) According to a first aspect of the present disclosure, a non-transitory computer-readable storage medium storing a computer program is provided. The computer program controls a processor to execute visualizing processing of displaying virtual lines visualized in positions of axial lines with respect to a plurality of twisting joints of a robot when a predetermined condition is satisfied.

According to the computer program, the virtual lines are displayed in the positions of the axial lines of the plurality of twisting joints, and thereby, the teacher may easily determine the closeness to the singular configuration in which the axial lines of the two twisting joints are aligned in a straight line. Further, the teacher may easily recognize that the singular configuration is avoidable by the operation to set the angle between the two virtual lines not to 0 degrees.

(2) In the above described computer program, the visualizing processing may be executed on a three-dimensional image of the robot contained in a simulation image for teaching of the robot.

According to the computer program, an operation to avoid the singular configuration may be easily recognized in the simulation image.

(3) In the above described computer program, the condition may include reception of an instruction to teach the robot from the teacher.

According to the computer program, a plurality of visualized axial lines may be displayed according to the instruction by the teacher.

(4) In the above described computer program, the condition may include reception of an instruction to display the virtual lines from the teacher.

According to the computer program, the virtual lines may be displayed according to the instruction by the teacher.

(5) In the above described computer program, the condition may include an angle between two axial lines of the axial lines of the plurality of twisting joints being equal to or smaller than a predetermined threshold.

According to the computer program, when the angle between the two axial lines is equal to or smaller than the threshold and the configuration is close to the singular configuration, the closeness to the singular configuration may be warned to the teacher by display of the plurality of visualized axial lines.

(6) In the above described computer program, the visualizing processing may include processing of changing a color of at least one of two virtual lines corresponding to the two axial lines to a color different from a color when the angle exceeds the threshold, when the angle between two axial lines of the axial lines of the plurality of twisting joints is equal to or smaller than the predetermined threshold.

According to the computer program, when the angle between the two axial lines is equal to or smaller than the threshold and the configuration is close to the singular configuration, the closeness to the singular configuration may be warned to the teacher by changing of the color of the virtual line.

(7) In the above described computer program, the visualizing processing may include processing of displaying an operation instruction to prompt the teacher to perform an operation to increase the angle between the two axial lines when the angle between two axial lines of the axial lines of the plurality of twisting joints is equal to or smaller than the predetermined threshold.

According to the computer program, an operation to separate the configuration from the singular configuration may be notified to the teacher.

(8) In the above described computer program, the visualizing processing may include processing of displaying a dangerous area showing closeness to a singular configuration near the two virtual lines corresponding to the two axial lines when the angle between two axial lines of the axial lines of the plurality of twisting joints is equal to or smaller than the predetermined threshold.

According to the computer program, the dangerous area close to the singular configuration may be notified to the teacher.

(9) According to a second aspect of the present disclosure, a teaching method for a robot is provided. The teaching method includes visualizing of displaying virtual lines visualized in positions of axial lines with respect to a plurality of twisting joints of a robot when a predetermined condition is satisfied.

According to the teaching method, the virtual lines are displayed in the positions of the axial lines of the plurality of twisting joints, and thereby, the teacher may easily determine the closeness to the singular configuration in which the axial lines of the two twisting joints are aligned in a straight line. Further, the teacher may easily recognize that the singular configuration is avoidable by the operation to set the angle between the two virtual lines not to 0 degrees.

The present disclosure can be realized in other various aspects than those described as above. For example, the present disclosure may be realized in aspects of a robot system including a robot and a robot control apparatus, a computer program for realizing functions of the robot control apparatus, a non-transitory storage medium in which the computer program is recorded, etc.

What is claimed is:

1. A non-transitory computer-readable storage medium storing a computer program, the computer program controlling a processor to execute visualizing processing of displaying virtual lines visualized in positions of axial lines with respect to a plurality of twisting joints of a robot when a predetermined condition is satisfied.

2. The non-transitory computer-readable storage medium according to claim 1, wherein
the visualizing processing is executed on a three-dimensional image of the robot contained in a simulation image for teaching of the robot.

3. The non-transitory computer-readable storage medium according to claim 1, wherein
the condition includes reception of an instruction to teach the robot from a teacher.

4. The non-transitory computer-readable storage medium according to claim 1, wherein
the condition includes reception of an instruction to display the virtual lines from a teacher.

5. The non-transitory computer-readable storage medium according to claim 1, wherein
the condition includes an angle between two axial lines of the axial lines of the plurality of twisting joints being equal to or smaller than a predetermined threshold.

6. The non-transitory computer-readable storage medium according to claim 1, wherein
the visualizing processing includes processing of changing a color of at least one of two virtual lines corresponding to two axial lines to a color different from a color when an angle between the two axial lines of the axial lines of the plurality of twisting joints exceeds a predetermined threshold, when the angle is equal to or smaller than the threshold.

7. The non-transitory computer-readable storage medium according to claim 1, wherein
the visualizing processing includes processing of displaying an operation instruction to prompt a teacher to perform an operation to increase an angle between two axial lines when the angle between the two axial lines of the axial lines of the plurality of twisting joints is equal to or smaller than a predetermined threshold.

8. The non-transitory computer-readable storage medium according to claim 1, wherein
the visualizing processing includes processing of displaying a dangerous area showing closeness to a singular configuration near two virtual lines corresponding to the two axial lines when an angle between the two axial lines of the axial lines of the plurality of twisting joints is equal to or smaller than a predetermined threshold.

9. A teaching method for a robot comprising visualizing of displaying virtual lines visualized in positions of axial lines with respect to a plurality of twisting joints of a robot when a predetermined condition is satisfied.
